(19) United States
(12) Patent Application Publication
(10) Pub. No.: US 2023/0162116 A1
(43) Pub. Date: May 25, 2023

(54) Integration of Physical Security Modeling and Simulation with Dynamic Probabilistic Risk Assessment

(71) Applicants: John A. Halsema, Vienna, VA (US); Christopher A. Guryan, Vienna, VA (US); Steven Prescott, Vienna, VA (US); Ben Russell, Vienna, VA (US)

(72) Inventors: John A. Halsema, Vienna, VA (US); Christopher A. Guryan, Vienna, VA (US); Steven Prescott, Vienna, VA (US); Ben Russell, Vienna, VA (US)

(21) Appl. No.: 17/866,843

(22) Filed: Jul. 18, 2022

Related U.S. Application Data
(60) Provisional application No. 63/222,563, filed on Jul. 16, 2021.

(51) Int. Cl. G06Q 10/0635; G06Q 10/0637

(52) U.S. Cl. CPC G06Q 10/0635; G06Q 10/06375

(57) ABSTRACT

A method of integrating a probabilistic risk assessment (“PRA”) tool and a security risk assessment (“SRA”) tool, said method comprising creating at least one simulation by the SRA tool; communicating the at least one simulation to the PRA tool; continuing the at least one simulation for a period of time; and monitoring, by the PRA tool, a site's condition.

### CROSS REFERENCE TO RELATED APPLICATIONS

This application claims priority to, and the benefit of, pending U.S. Provisional Patent Application No. 63/222,563 filed on Jul. 16, 2021.

### STATEMENT OF GOVERNMENT SPONSORED RESEARCH

This material is based upon work supported by the Department of Energy under Award Number DE-SC0020873.

### BACKGROUND

In the prior art, nuclear power plant security risk assessment (“SRA”) is separated from nuclear plant safety probabilistic risk assessment (“PRA”) in most respects. Safety and security systems are evaluated, monitored, exercised, and measured using very different methods, yet they are interrelated. A safety analysis yields an estimate of an undesirable outcome, such as core damage, based on a range of possible normal and abnormal operating conditions. In contrast, a security risk analysis estimates the effectiveness of security systems at preventing specific adversary actions, like destroying a pump or generator at a site, vice simulating the impact of this damage when operators can take alternative plant operations. Since a detailed model of the plant's operations after damage by an adversary is not available, a security analysis typically does not analyse reactor system's state after the plant is damaged. Instead, adversaries achieving objectives related to target sets are used as a surrogate to predict future core damage or the release of radiation. If the adversaries reach their objectives, the system fails regardless of other actions onsite personnel could take.

The prior art does not recognize analytical, quantitative methods were not available for evaluating the impact of components or system damage, unlike safety which has used probabilistic risk assessment (PRA) for many years. A better quantitative assessment would include the security risk's impact on overall plant safety and operations.

The present disclosure provides a solution lacking in the prior art. (Specifically, in one illustrative embodiment, using a dynamic PRA software tool, specifically, Event Modeling Risk Assessment using Linked Diagrams (“EMRALD”), and Automated Vulnerability Evaluation for Risks of Terrorism (“AVERT®”), the security assessment software tool.) The present disclosure allows for 2-way communications between the SRA tool and the PRA tool. In the combined system, the SRA tool tracks the state of security-related items such as adversaries, security forces, and some plant operators as a security event evolves, while the PRA tool tracks the state of the plant and determines operator procedure success during the event.

### BRIEF DESCRPTION OF THE DRAWINGS

To further illustrate the advantages and features of the present disclosure, a more particular description of the invention will be rendered by referenced to specific embodiments thereof which are illustrated in the appended drawings. It is appreciated that these drawings are not to be considered limiting in scope. The invention will be described with additional detail through the use of the accompanying drawings in which:

FIG. 1 shows a schematic simulation flow through a PRA tool.

FIG. 2 outlines the process used in performing an SRA tool analysis.

FIG. 3 shows the fundamental interaction between the PRA tool and the SRA tool.

FIG. 4 shows a model of a nuclear power plant.

FIG. 5 shows the security layers defining the public areas, owner-controlled areas, protected areas, and radiological controlled areas of the nuclear power plant of FIG. 4.

FIG. 6 shows various important areas of the nuclear power plant of FIG. 4.

FIG. 7 shows the main diagram of one embodiment of a simulation of the present disclosure.

FIG. 8 shows one embodiment of the Alternate Control Diagram of the present disclosure.

FIG. 9 shows one embodiment of the nuclear plant's process during a blackout.

FIG. 10 shows one embodiment of monitoring a nuclear power plant's diesel generators.

FIG. 11 shows one embodiment of a operator diagram.

FIG. 12 shows one embodiment of the manual operation process for running the steam-driven cooling pump.

FIG. 13 shows a Sankey diagram.

### DETAILED DESCRIPTION

PRA tools are well known in the prior art. One such example is EMRALD. EMRALD is a dynamic PRA tool based on three-phase discrete event simulation that includes the order and time in which events occur in the analysis of the model. Dynamic PRA is a recent development for nuclear power plant risk analysis, and research is showing benefits in areas such as human performance modeling, detailed system insights, and external events. The Nuclear Regulatory Commission recognizes the increased use and benefits of dynamic PRA, providing a seminar to their reviewers to better understand methods and models forthcoming from the industry. Dynamic PRA was recently identified as a potential solution for increasing realism and incorporating additional defense strategy options into physical security modeling. While traditional PRA models help determine target sets that are then used in security analysis, they are not well suited for coupling directly with physical security simulations because of their static nature. Some of the most significant limitations for physical security are operator procedures and timing of inputs to thermal-hydraulics analysis to determine core damage or the release of radiation to the environment.

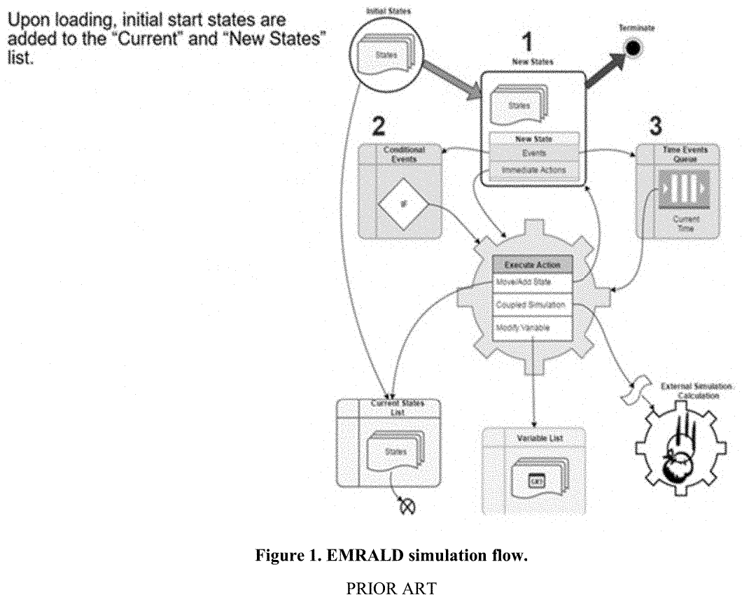

FIG. 1 shows a schematic simulation flow through a PRA tool such as EMRALD. EMRALD modeling allows the user to do the following in their models: analyze time-dependent conditions, adjust failure rates conditionally, model feedback loops, setup, run, and process results from external applications and dynamically couple with other codes.

After running the EMRALD model, the user can obtain probabilistic results and see dynamic benefits such as timing and event sequences. Results are output in a JavaScript Object Notation (“JSON”) tree structure (or perhaps other performed file format) which maps all the paths and timing information for how the monitored outcomes were reached. This data allows for visual display or data mining methods for determining critical links that lead to the outcomes.

SRA tools are also known in the art. One such tool is AVERT®. AVERT® is a modeling and simulation tool that provides in-depth evaluations of a site's vulnerability to a terrorist attack. AVERT® is a robust software suite focused on security. As an agent-based, Monte Carlo simulation, AVERT® simulates large numbers of attacks under varying conditions with simulated security features (e.g., sensors, barriers, and security forces) and adversaries responding to simulated events. Software agents represent security forces and adversaries. Security forces have attributes such as weapons, equipment, sensors, and models of their normal operations and response procedures, while the adversaries also have weapons, equipment, and sensors but are assigned targets as objectives and strategies to accomplish. During a simulated attack, the adversaries attempt to reach their objective, and the security forces try to prevent this. Over large numbers of simulated attacks calculated statistical metrics estimate the overall effectiveness of the security system and provide insight into which subsystems may be the most significant contributors to overall security. AVERT® creates detailed risk assessment reports which supply a crucial component of the information a site manager or commander needs to make effective security decisions. The reports include information about the physical security and protective force effectiveness in protecting a site against attacks from land, air, or water.

AVERT's® 3D Graphical User Interface (“GUI”) provides the ability to model a site or critical area using real-world data and representations. This accurate modeling shortens the learning curve for the software and provides simulation results and analyses in an easy-to-evaluate format. The flexibility of the GUI, along with its easily controllable and customizable sampling variables, allows users to quickly perform complex ‘what-if’ analyses that provide the critical information needed to optimize the site security system.

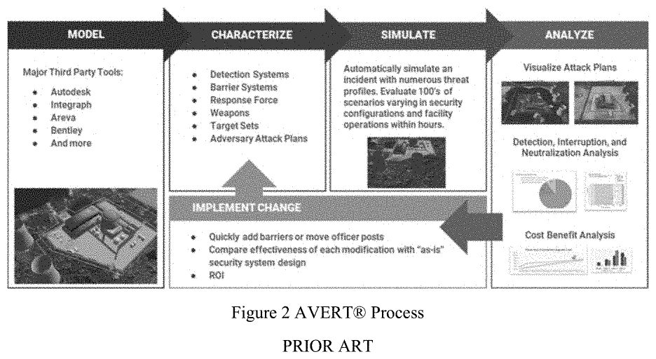

FIG. 2 outlines the process used in performing an SRA tool analysis using a tool such as AVERT®. The first step is to create a 3D model of the facility to be analyzed, sometimes referred to as a digital twin, typically from a combination of geographic information systems (“GIS”) data describing the facility's terrain and computer-aided design (“CAD”) data for detailed building plans. AVERT® consumes the 3D model, and then security features, including detection systems, barrier systems, and other components, are added.

The AVERT® model at this point contains all the 3D elements required for a digital threat assessment: comprehensive topology, road network, utilities, building exteriors, doors, windows, building interiors, permanent barriers, temporary barriers, pop up barriers, gates, stairs, detectors, sensors, cameras, locks, alarms, and risk-sensitive areas such as communication hubs, etc.

Security force and adversary agents are added to the model to complete the ‘model characterization’ phase. All agents can have sensors, weapons, equipment, and vehicles. Security force agents have normal operations defined, such as a patrol route or a fixed post. Security forces also have response procedures to address an adversary attack, such as pursuing the adversary, moving to a point to interdict an adversary, and many other options. Adversary agents may have explosives, breaching tools, and other equipment, and must have one or more objectives to reach and damage. Analysis, typically by subject matter experts, identifies potential targets for an adversary, often based on target sets partially derived from data in the PRA. Finally, many configuration options are available for the tactics employed by both the adversary and security force agents.

AVERT® uses statistical models to describe agent characteristics, weapon characteristics, detector performance, barrier characteristics, and other related components. A library integrated with AVERT® contains the statistical description of these components, including specifying the distribution for the probabilistic parameters.

With the characterized model completed, AVERT® simulates a statistically significant number of attacks. As the simulation proceeds, a random number generator is used to select the value to use for each random variable needed. For example, agents move at speeds that are not deterministic: the speed is a random variable related to the agent's platform, the terrain, and the operating conditions. The statistical description for this, and all other AVERT® variables, is in the library. In each simulated attack, the random number generator provides a value to select the agent speed for each agent and each condition encountered. Many hundreds of attacks are simulated with new random values provided, such that each simulation is independent.

Every event in every simulation, including all agent movements, detections, shots fired, and other events, is stored in a relational database available for use in risk assessment analysis. Numerous statistical calculations can be computed, such as probabilities of detection or neutralization in a given attack, for all simulations of a particular configuration, or even analysis across various system configurations. One advantage of storing all the events with associated data in a relational data model is the ability to do analysis using external tools to answer questions without being limited to the existing statistical reports. These results can be analyzed using several reports, and the analysis can inform changes to the security posture. SQL Server reporting, integrated with AVERT®, allows an analyst to generate new queries. AVERT® provides statistical data derived from simulations that employ probabilistic distributions to support risk assessment methodologies, a core feature of PRAs.

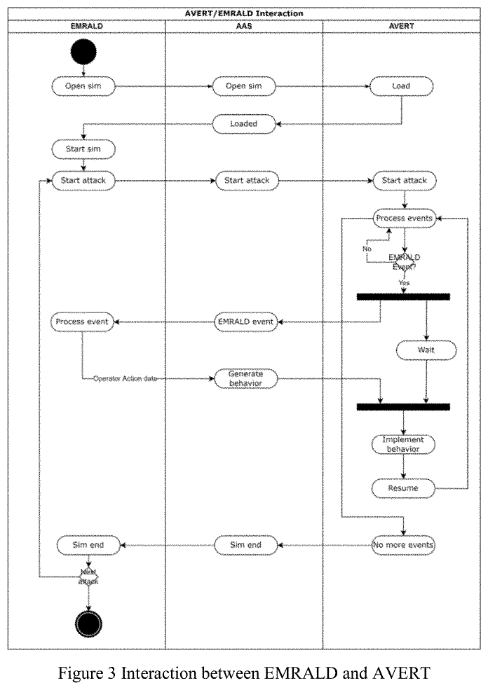

FIG. 3 shows the fundamental interaction between the PRA tool and the SRA tool. A middleware layer, the SRA tool as a service, mediates between the PRA tool is XMPP protocol and the messaging used by the SRA tool. This allows the tools to exchange messages in a standard format such as JSON. These messages manage the SRA tool's program state (e.g., loading a 3D model and starting a simulation), allowing it to communicate with the PRA tool about simulation events of interest, and let the PRA tool order operators in the model to take actions based on the state of the site. Based on the SRA tool's simulation, the PRA tool tracks the state of the site from a plant operations perspective, as discussed below. Based on the plant state, the PRA tool determines what mitigating actions the operators can take. The SRA tool's model the progresses, considering the operations directed by the PRA tool. With the new behavior of operators in place, the simulation runs to completion and reports results back to the PRA tool, which again tracks the state of the site.

At the start of a set of simulations, the PRA tool sends a message to the SRA tool, requesting that the SRA tool load the model to be studied. The model is loaded and simulates a single attack. The simulated attack continues until an event of interest occurs, all adversaries are neutralized, or a maximum simulation time is reached. This maximum simulation time, representing the arrival and deployment of systems such as FLEX equipment, is drawn from a probability distribution and can be easily adjusted based on specific requirements.

Events of interest include an adversary being detected, an adversary or operator reaching an objective, or an adversary, operator, or responder being neutralized. The events of interest can be generalized to any event type processed by the SRA tool's simulation engine. On receipt of any of these events, the PRA tool determines the plant state and determines what actions, if any, plant operators should take to maintain the plant in a safe state. The PRA tool then transmits a message to the SRA tool that directs simulated operators to perform those actions. The SRA tool incorporates the actions into the simulated operators' behavior and continues its simulation. The simulation continues until the next event of interest occurs, or until the simulation ends.

When the simulation is complete, the SRA tool sends a message to the PRA tool indicating that the simulation has ended. The PRA tool can then start a new simulated attack using the same model. This overall process repeats many times until a statistically significant number of attacks have been simulated. The SRA tool stores the complete set of simulation events in a SQL database for later analysis.

### Proof of Concept

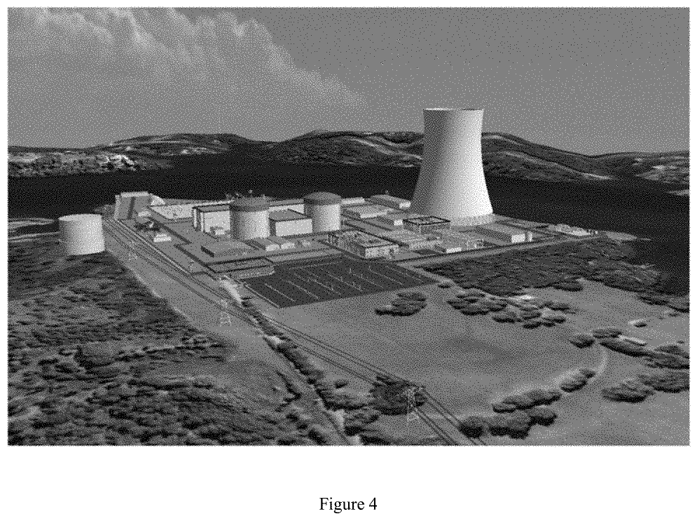

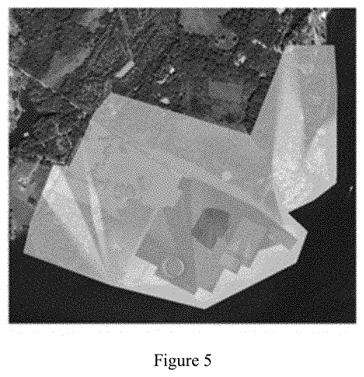

One illustrative example of the power of the combined SRA/PRA tool system using a fictional nuclear power plant is provided below. A model of the plant is shown in FIG. 4. The model is based on open-source GIS data. GIS data was imported into Autodesk InfraWorks to create a 3D model (or twin) of the terrain. The plant, including the power-generation building and administrative building with detailed interiors, was added to the InfraWorks model using Autodesk Maya, and the resulting geometry was imported into AVERT®. FIG. 5 shows the security layers defining the public areas, owner-controlled areas, protected areas, and radiological controlled areas. The security features modeled in AVERT® include detectors, barriers, response personnel, and plant operators. In addition, adversary agents are modeled.

### Site Defenses

The site is protected by numerous levels of security mechanisms, including a set of detectors, barriers, and a response force. The response force has deliberately been made more vulnerable than would be typical at a U.S. nuclear facility so that rare events, like the adversary team reaching their objectives, can be observed in a significant percentage of the Monte Carlo simulations. Primary detection is provided by a perimeter intrusion detection system (“PIDS”). The PIDS is located inside a double fence that surrounds the site except at the entry control point and a second gate that is reinforced with a crash-beam-type vehicle barrier.

The response force consists of five fixed posts in elevated bullet-resistant enclosures and two backup force responders located in the power-generation building. The fixed posts have a secondary detection function; their eyes and ears can independently detect an adversary. The fixed posts respond to a detected threat by opening the gun port facing the adversary and engaging it. The backup force responds by finding an intercept path to the last reported enemy position and engaging using standard small team tactics. The SRA tool's guard response mechanism controls the overall behavior of both the fixed posts and the backup force. However, the backup force uses the cover advanced behavior to allow agents to move away from their planned path to take advantage of cover and employ cover-and-advance tactics.

In a realistic model of a nuclear facility security posture, there would be a very low probability of adversaries achieving their objectives and triggering the need for operator actions during the attack. Therefore, to allow a higher frequency of target damage to occur in the simulations, the physical security protection features in the SRA tool model were reduced. This reduction in security system capability provides a better analysis of the defensive strategies invoked when these targets are damaged.

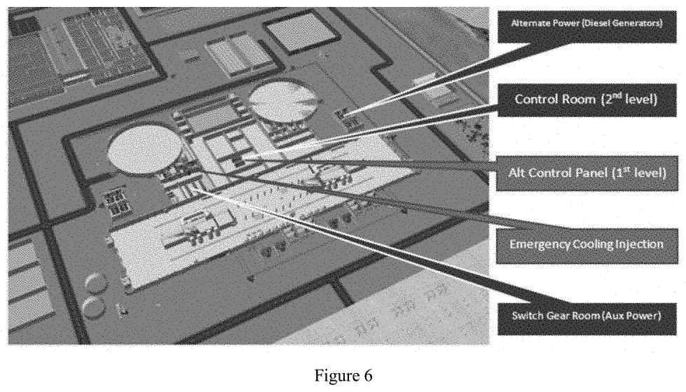

The adversaries are assigned to two teams, Team 1 and Team 2. In this fictitious attack set, prior to the start of a simulation, the adversaries cause a loss of offsite power event. Team 1 plans to take over the control room, located in the power-generation building. Team 2 plans first to destroy the diesel generators providing alternate power and then proceed to the switchgear room to destroy auxiliary power. The control room and other objectives are shown in FIG. 6.

In addition to adversaries and responders, the SRA tool models include two agents representing plant operators in different locations. These operators may be tasked by the PRA tool, as described in the following section, depending on the plant state as the attack evolves. Operators can be sent to manually run a steam-driven cooling pump (referred to as Emergency Cooling Injection in FIG. 6) or the alternate control panel (Alt Control Panel in FIG. 6). An additional two security personnel act as escorts to protect the operators s they move through the site before it has been fully secured.

The goal of the PRA tool model is to capture the plant procedures and condition of the plant, given there is an attack. To do this the model does the following: start and stop the SRA tool model as needed, communicate operator tasks to the SRA tool, receive and keep track of when any targets events occur in the SRA tool, determine procedure or action whenever a target is hit, determine what to do if an operator is killed, evaluate when plant damage could occur given previous events.

The PRA tool safety model consists of three plant diagrams (i.e., Main, AltControl, and NoAuxPower) and four component diagrams (i.e., OP1, OP2, DieselGens, and SteamPumpManual). The diagrams are described in the following sections.

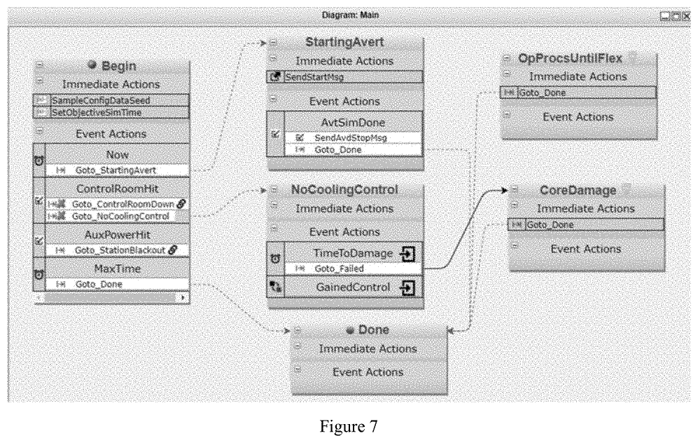

The Main diagram, shown in FIG. 7, is the key starting and ending point of the simulation. It begins with the assumption of an attack and starts the SRA tool simulation, monitors the condition of the plant, and determines if there was core damage. If there is no cooling for more than 1 hour then it is assumed that core damage occurs. This piece could easily be replaced with a thermal hydraulics analysis that depended on plant shutdown time and target times to get a more accurate time for actual core damage.

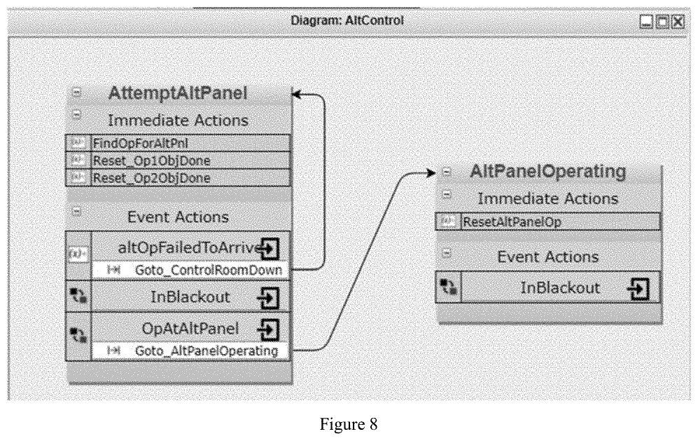

The AltControl diagram, shown in FIG. 8, determines what operator to send to the alternate control panel if the control room is hit and then monitors the use of the control panel. If all power to the plant is lost, called Station Blackout, then operation at the alternate panel is needed.

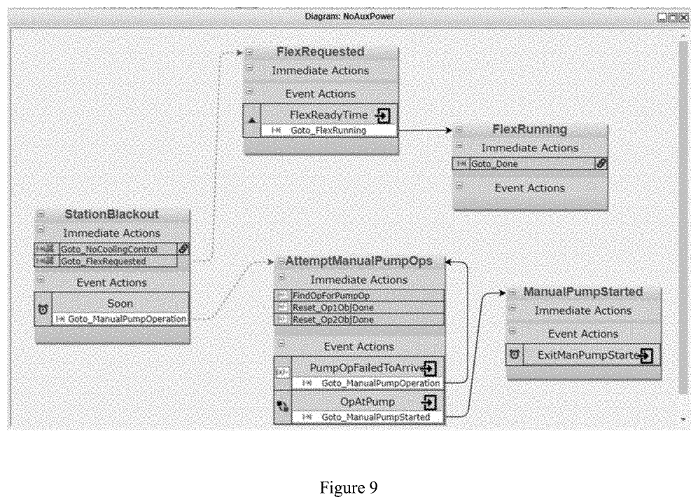

This diagram, shown in FIG. 9, describes the plant's process during a station blackout event from an attack. Offsite assistance is requested, and an operator is selected to manually run a steam-driven cooling pump.

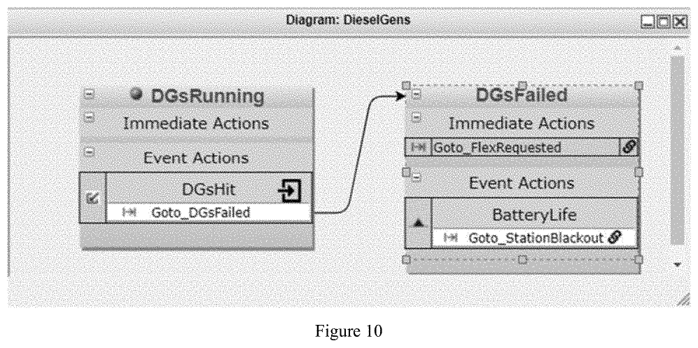

The DieselGens diagram, shown in FIG. 10, monitors if the diesel generators are running and then how long battery life lasts before causing a station blackout. This ties to the SRA tool model and if an adversary destroys the generators in the SRA tool simulation, then the PRA tool state shifts from DGsRunning to DGsFailed.

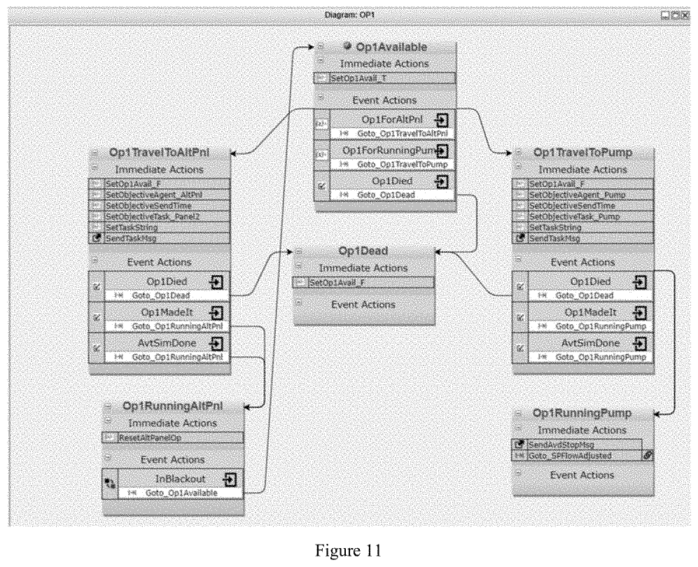

The Op1 and Op2 diagrams are similar and model the possible states an operator can be in. Both operators can perform the same tasks, including traveling to and operating the alternate control panel or traveling to and operating the steam-driven pump. If the operator in the SRA tool model dies, then the PRA tool model also puts the operator into a state where they cannot perform any actions. The Op1 diagram is shown in FIG. 11.

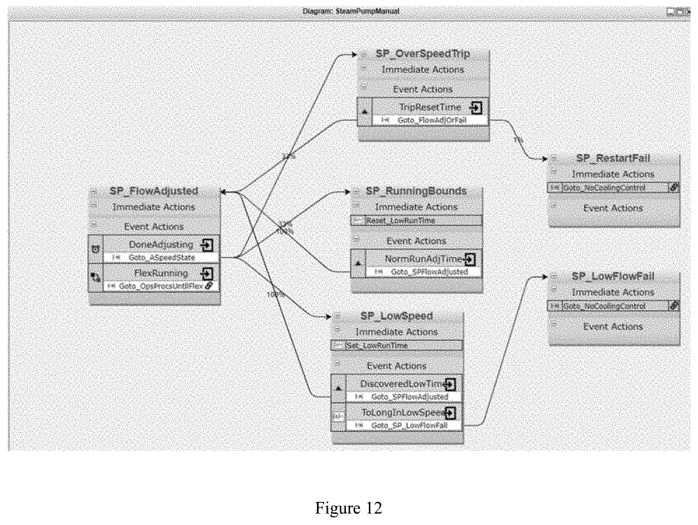

This diagram, shown in FIG. 12, captures the manual operation process for running the steam-driven cooling pump. During manual operation of this pump, the operator adjusts the flow, potentially resulting in an over-speed trip, or running within requested bounds, or running low. After a time, a feedback loop calls for the flow to be adjusted repeatedly. The operator continues to run the pump until it fails due to a bad trip restart, or the system runs in a low-flow state for too long, causing core damage; or offsite help arrives to restore power/other cooling.

### Results

The initial model intentionally provided a high likelihood that the adversaries would reach their targets and therefore trigger the operator response to the damaged site. However, the core damage frequency was very high because the security strategy for protecting the operators was ineffective. In this model, a single security force member escorted the operator without coordinating with other security personnel. Later in the project, more appropriate models provided better protection for the operators. In one model the security strategy was modified to allow response forces to intercept nearby adversaries before operator tasks started. The new model increased the likelihood that operators would reach their designated locations and execute the required operation in the required time, demonstrating the value of a coupled operations and security simulation.

The results of the combined model provide values for several variables, including:
The probability of adversaries achieving their targets
The probability of operators reaching their objectives
The probability of operators successfully operating equipment over an extended time
The probability of core damage when including plant operator procedures
The number of fatalities to operators, security personnel, and adversaries

Additionally, all the causes or paths that lead to core damage were recorded. This data can be used to assess the most critical areas that can be modified to further reduce risk. For example, if the top path of failure after an attack was the operator failing to run the pump until offsite help could be achieved, then training could be used to increase operator effectiveness; or if operators were likely to be killed in going to a task, then a delay or other protective measures could be added.

Some results are similar to traditional PRA results, such as showing probabilities, while other features, such as cut sets or importance measures, are not the same. Instead of the top minimal cut sets that cause core damage, the top paths that lead to the outcome are identified. A metric similar to importance measures has not yet been established and is the focus of future research, but data mining and visualization tools can be used to determine correlated events or times. A different view of the analysis between the combined system and a standard PRA can be helpful for decision-makers. While PRA analysts understand current PRA metrics, it is easier for other analysts and decision-makers to see a timeline of events that it is caused an outcome to support developing methods for mitigation.

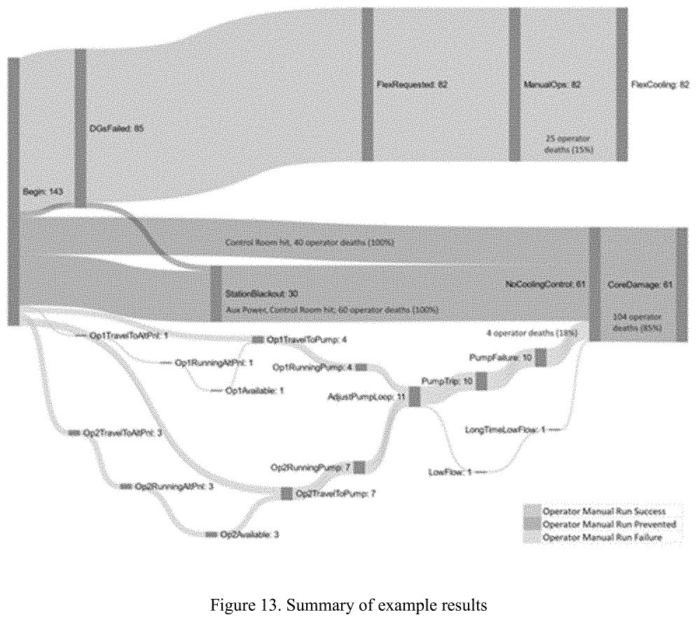

To summarize the results of our simulations, we plotted chains of events leading to each of two end states (core damage or no core damage) as a Sankey diagram, shown in FIG. 13. This figure shows how significant insights can be gleaned from a simple graph. At a glance we can see that the addition of operator actions reduces the probability of core damage by more than half, and that failure to run emergency equipment is a comparatively small contributor to core damage.

In this analysis, a total of 180 attacks were simulated. Of these, 37 runs had a simulation error and were removed from the dataset. As discussed earlier, the security posture of the plant was weakened to increase the frequency of an adversary reaching its targets. This modified security posture increases the opportunity to analyze operator action effectiveness in a more significant number of cases. Due to these reduced protection measures, all 143 valid runs had attackers reaching at least one target that would normally cause core damage. In 82 attacks (57%), adversaries achieved their objectives, but operator actions were able to keep the site in a safe state, thus preventing core damage. In the remaining 61 attacks (43%), the adversaries were able to cause core damage.

In those 61 core damage scenarios, 50 (35%) occurred because the adversaries managed to neutralize the operators as they traversed the site to either the steam pump or alternate control panel. In eleven of the core attacks (8%), the operators were directed to the steam pump and were able to get there safely but were unable to operate the pump long enough to maintain cooling until Flexible Mitigation Capability (“FLEX”) equipment arrived from offsite.

Several strategic insights can be drawn from these results. First, the results show that operators can save the plant in 82 of 93 (88%) attacks if they make it to their tasks. Conversely, more training to reduce operator errors on the pump, or reducing the time it takes to get FLEX operational, would have a minimal decrease in core damage. The results show that the first effort should be devoted to developing a strategy to make sure operators are physically able to make it to their task locations. Operators are more likely to reach their stations to carry out operator actions and prevent core damage by improving operator security protection or delaying the response until security forces fully secure the area. This same model could evaluate those types of options to pick the most optimal and cost-effective solution.

Modeling and simulation technology can link physical security simulations with dynamic PRA and provide insights into the effectiveness of operator actions in preventing core damage. The simulations demonstrated that the operators could prevent core damage when there is a coordinated response between security and operations. The plant can develop plans and procedures for operators to successfully implement the necessary actions to protect the core in the event of damage caused by a security event, guided by the simulation results. The Monte Carlo simulation data provides considerable insights into how operators and plant security personnel can coordinate to implement the operator actions more effectively.

Although the two applications, the SRA tool and the PRA tool, were developed independently, coupling the two through a message bus using standard protocols with command and data structures defined, successfully integrated the two products to perform an integrated Monte Carlo simulation that provided meaningful data.

Coordination between operators and security personnel had a significant impact on the effectiveness of implementing operator actions. Overly simple security procedures, such as providing only an escort for responders, resulted in several cases where operators could not reach the locations necessary to implement the necessary action or could not remain in the locations long enough to complete the actions. More advanced strategies are necessary to improve the effectiveness of the operators.

The system can effectively model other events used in PRA analysis, such as the probability of equipment failure, operator errors, and others. The simulation provided insights into other activities such as improving operator training, pre-staging critical backup equipment, and other activities that can improve the likelihood of success in operating the emergency system and the effectiveness of the operator actions.

Visualization of the entire scenario is essential to understand why actions were or were not successful. Both the SRA tool and the PRA tool provided various data analysis and visualization tools essential in conducting the necessary analysis. However, while these tools provided considerable insight, a more integrated data model with an analysis toolset needs to be developed to provide more insight and simplify the process.

Typical results PRAs, such as traditional importance measures, are not the same when incorporating dynamic PRA with physical security. These types of coupled results are conditional probabilities, assuming that an attack has occurred without the probability of an attack occurring included in the calculation A “Delta Risk” or change in risk is easily obtained, but more importantly, failure paths show and rank the “how, where, and when” of critical events. These paths are easily understood and provide the insights needed for incorporating a strategy for operator actions during an attack.

Although particular embodiments of the present disclosure have been described, it is not intended that such references be construed as limitations upon the scope of this disclosure except as set forth in the claims.

We claim:

1. A method of integrating a probabilistic risk assessment (“PRA”) tool and a security risk assessment (“SRA”) tool, said method comprising:
a. creating at least one simulation by the SRA tool;
b. communicating the at least one simulation to the PRA tool;
c. continuing the at least one simulation until an event of interest occurs; and
d. monitoring, by the PRA tool, a site's condition.

2. The method of claim 1 wherein the creating at least one simulation step requires the creation of a 3D model of a site.

3. The method of claim 2 wherein the 3D model is composed of at least one of geographic information systems (“GIS”) and computer-aided design (“CAD”) data for detailed building plans.

4. The method of claim 3 wherein the 3D model is composed of a combination of geographic information systems (“GIS”) and computer-aided design (“CAD”) data for detailed building plans.

5. The method of claim 1 wherein the event of interest is selected from the group consisting of an adversary being detected, an adversary or operator reaching an objective, or an adversary, operator, or responder being neutralized.

6. The method of claim 4 wherein the event of interest is selected from the group consisting of an adversary being detected, an adversary or operator reaching an objective, or an adversary, operator, or responder being neutralized.

7. The method of claim 1 wherein the sites condition is communicated by the PRA tool to the SRA tool.

8. The method of claim 4 wherein the sites condition is communicated by the PRA tool to the SRA tool.

9. The method of claim 6 wherein the sites condition is communicated by the PRA tool to the SRA tool.

10. A method of integrating a probabilistic risk assessment (“PRA”) tool and a security risk assessment (“SRA”) tool, said method comprising:
a. creating at least one simulation by the SRA tool;
b. communicating the at least one simulation to the PRA tool;
c. continuing the at least one simulation for a period of time; and
d. monitoring, by the PRA tool, a site's condition.

11. The method of claim 10 wherein the creating at least one simulation step requires the creation of a 3D model of a site.

12. The method of claim 11 wherein the 3D model is composed of at least one of geographic information systems (“GIS”) and computer-aided design (“CAD”) data for detailed building plans.

13. The method of claim 12 wherein the 3D model is composed of a combination of geographic information systems (“GIS”) and computer-aided design (“CAD”) data for detailed building plans.

14. The method of claim 10 wherein the period of time ends upon the earlier of event of interest occurring, all adversaries being neutralized or a maximum time being reached.

15. The method of claim 14 wherein the event of interest is selected from the group consisting of an adversary being detected, an adversary or operator reaching an objective, or an adversary, operator, or responder being neutralized.

16. The method of claim 11 wherein the period of time ends upon the earlier of event of interest occurring, all adversaries being neutralized or a maximum time being reached.

17. The method of claim 16 wherein the sites condition is communicated by the PRA tool to the SRA tool.
